(19) United States
(12) Patent Application Publication
(10) Pub. No.: US 2021/0367437 A1
(43) Pub. Date: Nov. 25, 2021

(54) Device Charging Station Apparatus

(71) Applicant: Quincey Butler, Hawthorne, CA (US)

(72) Inventor: Quincey Butler, Hawthorne, CA (US)

(21) Appl. No.: 16/880,609

(22) Filed: May 21, 2020

(51) Int. Cl. H02J 7/00; H02J 7/02; G07C 9/00; G07C 9/20

(52) U.S. Cl. CPC H02J 7/0045; H02J 7/02; G06Q 30/0241; G07C 9/00174; G07C 9/20; H02J 7/0047

(57) ABSTRACT

A device charging station apparatus for offering convenient a charging solution and new revenue for businesses includes a housing and a plurality of cubby doors to selectively cover or expose a plurality of cubby apertures of the housing. A plurality of charging ports is coupled to the housing within the cubby apertures. A payment interface is coupled to the housing and includes a pay display, a keypad, and a card reader in operational communication with a CPU. A power source is coupled to the housing and is in operational communication with the electronic lock of each of the plurality of cubby doors, the plurality of charging ports, the CPU, and the payment interface.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to charging devices and more particularly pertains to a new charging device for offering convenient a charging solution and new revenue for businesses.

### (2) Description of Related Art Including Information Disclosed Under 37 CFR 1.97 and 1.98

The prior art relates to charging devices and secure methods of offering charging in public. Existing devices do not offer a secure way to securely store many devices, including tablets and laptops, while offering a pay to charge solution to the public.

### BRIEF SUMMARY OF THE INVENTION

An embodiment of the disclosure meets the needs presented above by generally comprising a housing having a housing front side, a housing back side, a housing left side, a housing right side, a housing top side, and a housing bottom side. The housing front side has a plurality of cubby apertures extending towards the housing back side. A plurality of cubby doors is coupled to the housing. Each cubby door selectively covers and alternatively exposes one of the cubby apertures. Each cubby door has an electronic lock to selectively engage the housing. A plurality of charging ports is coupled to the housing with each charging port coupled within one of the cubby apertures. A CPU is coupled to the housing and is in operational communication with the plurality of charging ports and the electronic lock of each of the plurality of cubby doors. A payment interface is coupled to the housing and includes a pay display, a keypad, and a card reader. The payment interface is in operational communication with the CPU. A power source is coupled to the housing and is in operational communication with the electronic lock of each of the plurality of cubby doors, the plurality of charging ports, the CPU, and the payment interface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a device charging station apparatus according to an embodiment of the disclosure.

FIG. 2 is a rear elevation view of an embodiment of the disclosure.

FIG. 3 is a front elevation view of an embodiment of the disclosure.

FIG. 4 is a detail view of an embodiment of the disclosure.

FIG. 5 is a detail view of an embodiment of the disclosure.

FIG. 6 is a block diagram of an embodiment of the disclosure.

### DETAILED DESCRIPTION OF THE INVENTION

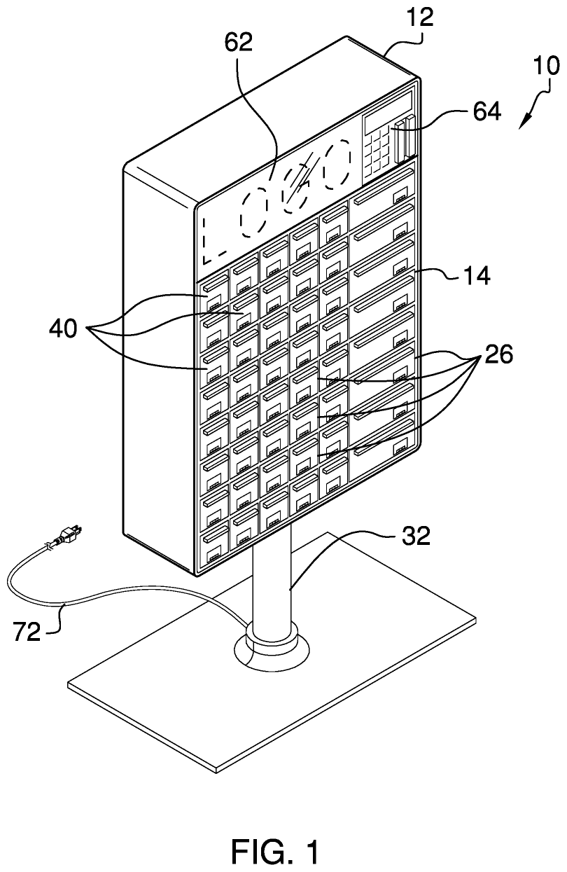

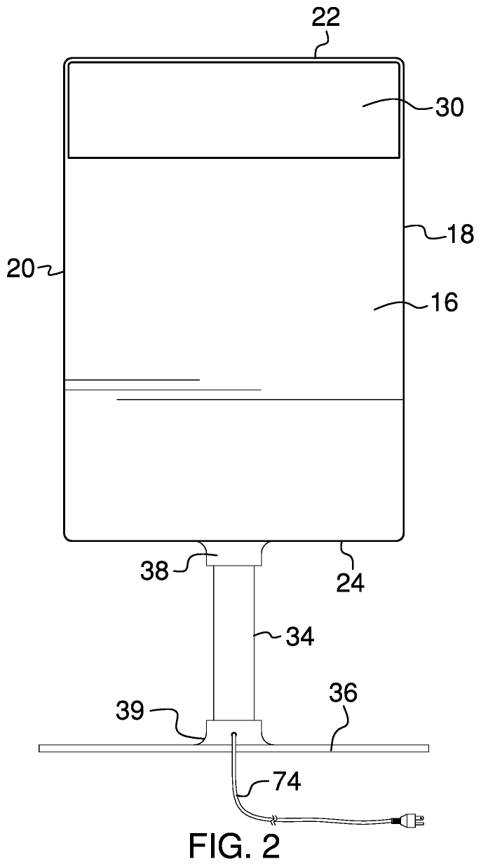

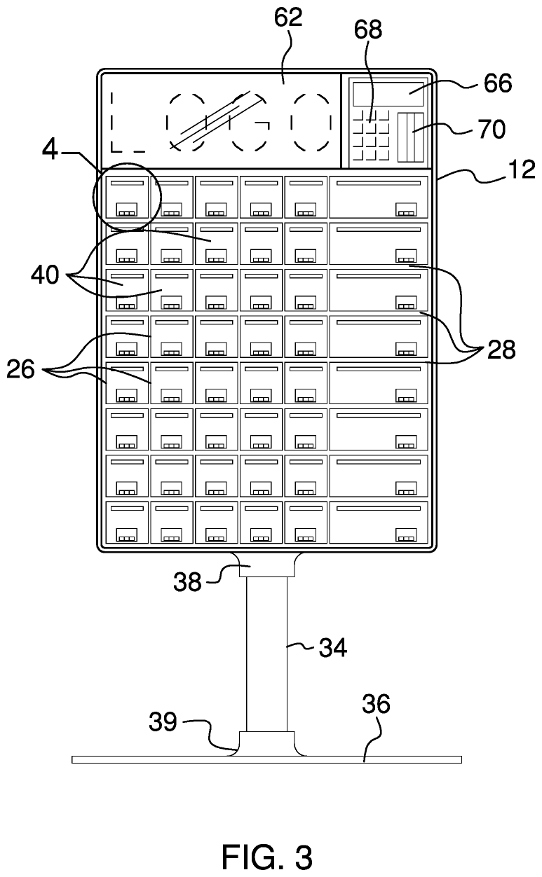

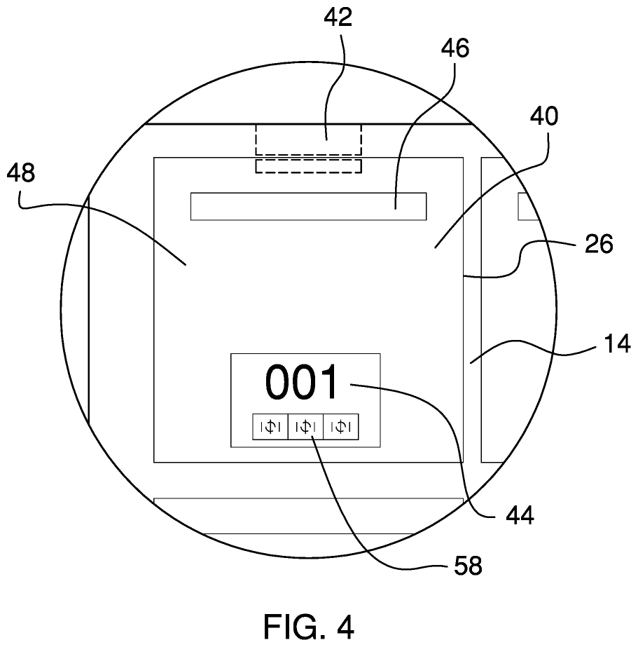

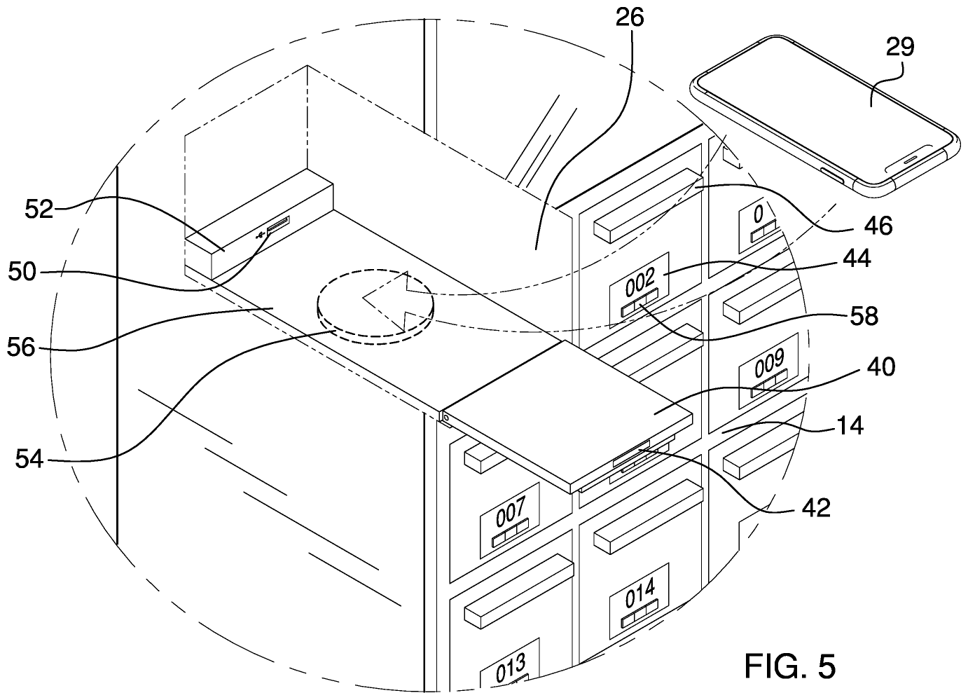

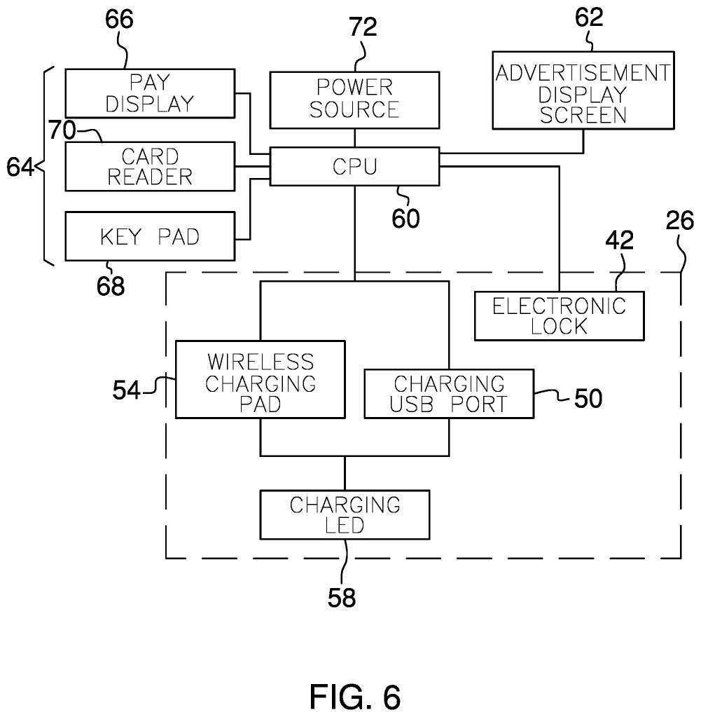

With reference now to the drawings, and in particular to FIGS. 1 through 6 thereof, a new charging device embodying the principles and concepts of an embodiment of the disclosure and generally designated by the reference numeral 10 will be described.

As best illustrated in FIGS. 1 through 6, the device charging station apparatus 10 generally comprises a housing 12 having a housing front side 14, a housing back side 16, a housing left side 18, a housing right side 20, a housing top side 22, and a housing bottom side 24. The housing front side 14 has a plurality of cubby apertures 26 extending towards the housing back side 16. The plurality of cubby apertures 26 may be arranged in a matrix extending from adjacent the housing left side 18 to adjacent the housing right side 20 and adjacent the housing bottom side 24. The plurality of cubby apertures 26 may include at least one column of larger cubby apertures 28 configured to hold a tablet or a laptop while the remainder of the plurality of cubby apertures 26 are configured to hold a cellphone 29.

The housing backside 16 may have a removable access panel 30 above the plurality of cubby apertures 26. The housing 12 may be rectangular prismatic with rounded edges. The housing 12 may be mounted on a wall or may alternatively have a stand 32 coupled to the housing bottom side 24. The stand 32 has a post 34 and a base plate 36. The post 34 may include an upper flange 38 and a lower flange 39 for structural support.

A plurality of cubby doors 40 is coupled to the housing 12. Each cubby door 40 selectively covers and alternatively exposes one of the cubby apertures 26. Each cubby door 40 has an electronic lock 42 to selectively engage the housing 12 and prevent exposure of the respective cubby aperture 26 until disengaged. The electronic lock 42 may be, but is not limited to, an electromagnet, a solenoid, or other electronically engageable locking members. Each cubby door 40 also includes a cubby number 44 and a handle 46. The handle 46 may be horizontal and perpendicularly extends from a facia 48 of the cubby door.

A plurality of charging ports 50 is coupled to the housing 12. Each charging port 50 is coupled within one of the cubby apertures 26. Each charging port 50 may include a rectangular prismatic adaptor 52 extending the width of the cubby aperture 26. A plurality of wireless charging pads 54 may be coupled to the housing 12. Each wireless charging pad 54 is coupled within one of the cubby apertures 26 and may be embedded in a cubby floor 56 of the cubby aperture.

A plurality of charge LEDs 58 is coupled to each cubby door 40. The plurality of charge LEDs 58 is in operational communication with the respective charge port 50 and is configured to display the charge level of the device being charged. The plurality of charge LEDs 58 may comprise an array of three charge LEDs 58 to demonstrate charge level either by the color displayed or by the portion of charge LEDs 58 that are illuminated.

A CPU 60 is coupled to the housing 12 and is in operational communication with the plurality of charging ports 50, the plurality of wireless charging pads 54, and the electronic lock 42 of each of the plurality of cubby doors. An advertisement display screen 62 may be coupled to the housing front side 14 above the plurality of cubby apertures 26. The advertisement display screen 62 is in operational communication with the CPU 60 to display still or video advertisements.

A payment interface 64 is coupled to the housing 12. The payment interface 64 may be coupled adjacent the advertisement display screen 62 and includes a pay display 66, a keypad 68, and a card reader 70. The payment interface 64 is in operational communication with the CPU 60 to disengage the electronic lock 42 of one of the plurality of cubby doors when payment has been tendered and when the user is ready to remove his or her device from the respective cubby aperture 26. A technician may service the payment interface 64, the CPU 60, or the advertisement display screen 62 by removing the access panel 30.

A power source 72 is coupled to the housing 12 and is in operational communication with the electronic lock 42 of each of the plurality of cubby doors, the plurality of charging ports 50, the plurality of wireless charging pads 54, the CPU 60, and the payment interface 64. The power source 72 may include a power cord 74 extending through the stand 32.

In use, the payment interface 64 is utilized to pay for a desired amount of charge time and to unlock the cubby door 40 to expose one of the plurality of cubby apertures 26. The user may then attach a device to the respective charging port 50 or place the device on the wireless charging pad 54 and close the cubby door 40 at which point the electronic lock 42 reengages to prevent theft. When done, the user again interacts with the payment interface 64 to open the cubby door 40 to retrieve his or her device.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A device charging station apparatus comprising:
a housing having a housing front side, a housing back side, a housing left side, a housing right side, a housing top side, and a housing bottom side, the housing front side having a plurality of cubby apertures extending towards the housing back side;
a plurality of cubby doors coupled to the housing, each cubby door selectively covering and alternatively exposing one of the cubby apertures, each cubby door having an electronic lock to selectively engage the housing;
a plurality of charging ports coupled to the housing, each charging port being coupled within one of the cubby apertures;
a CPU coupled to the housing, the CPU being in operational communication with the plurality of charging ports and the electronic lock of each of the plurality of cubby doors;
a payment interface coupled to the housing, payment interface including a pay display, a keypad, and a card reader, the payment interface being in operational communication with the CPU; and
a power source coupled to the housing, the power source being in operational communication with the electronic lock of each of the plurality of cubby doors, the plurality of charging ports, the CPU, and the payment interface.

2. The device charging station apparatus of claim 1 further comprising a plurality of wireless charging pads coupled to the housing, each wireless charging pad being coupled within one of the cubby apertures and being in operational communication with the CPU and the power source.

3. The device charging station apparatus of claim 1 further comprising an advertisement display screen coupled to the housing front side, the advertisement display screen being in operational communication with the CPU.

4. The device charging station apparatus of claim 1 further comprising a stand coupled to the housing bottom side, the stand having a post and a base plate.

5. The device charging station apparatus of claim 4 further comprising the post including an upper flange and a lower flange.

6. The device charging station apparatus of claim 1 further comprising the housing backside having a removable access panel.

7. The device charging station apparatus of claim 1 further comprising each cubby door having a handle.

8. The device charging station apparatus of claim 7 further comprising the handle being horizontal and perpendicularly extending from a facia of the cubby door.

9. The device charging station apparatus of claim 1 further comprising each cubby door having a cubby number.

10. The device charging station apparatus of claim 1 further comprising the plurality of cubby apertures being arranged in a matrix, the plurality of cubby apertures including at least one column of larger cubby apertures configured to hold a tablet or a laptop.

11. The device charging station apparatus of claim 1 further comprising a plurality of charge LEDs coupled to each cubby door, the plurality of charge LEDs being in operational communication with the charge port and configured to display the charge level of the device being charged.

12. The device charging station apparatus of claim 1 further comprising the housing being rectangular prismatic and having rounded edges.

13. A device charging station apparatus comprising:
a housing having a housing front side, a housing back side, a housing left side, a housing right side, a housing top side, and a housing bottom side, the housing front side having a plurality of cubby apertures extending towards the housing back side, the plurality of cubby apertures being arranged in a matrix, the plurality of cubby apertures including at least one column of larger cubby apertures configured to hold a tablet or a laptop, the housing backside having a removable access panel, the housing being rectangular prismatic and having rounded edges;
a stand coupled to the housing bottom side, the stand having a post and a base plate, the post including an upper flange and a lower flange;
a plurality of cubby doors coupled to the housing, each cubby door selectively covering and alternatively exposing one of the cubby apertures, each cubby door having an electronic lock to selectively engage the housing, a cubby number, and a handle, the handle being horizontal and perpendicularly extending from a facia of the cubby door;
a plurality of charging ports coupled to the housing, each charging port being coupled within one of the cubby apertures;
a plurality of wireless charging pads coupled to the housing, each wireless charging pad being coupled within one of the cubby apertures;
a CPU coupled to the housing, the CPU being in operational communication with the plurality of charging ports, the plurality of wireless charging pads, and the electronic lock of each of the plurality of cubby doors;
a plurality of charge LEDs coupled to each cubby door, the plurality of charge LEDs being in operational communication with the charge port and configured to display the charge level of the device being charged;
an advertisement display screen coupled to the housing front side, the advertisement display screen being in operational communication with the CPU;
a payment interface coupled to the housing, payment interface including a pay display, a keypad, and a card reader, the payment interface being in operational communication with the CPU; and
a power source coupled to the housing, the power source being in operational communication with the electronic lock of each of the plurality of cubby doors, the plurality of charging ports, the plurality of wireless charging pads, the CPU, and the payment interface.
